(19) United States
(12) Patent Application Publication
(10) Pub. No.: US 2022/0010244 A1
(43) Pub. Date: Jan. 13, 2022

(54) SURFACE TREATMENT AGENT

(71) Applicant: NIPPON PAINT SURF CHEMICALS CO., LTD., Ehinagawa-ku, Tokyo (JP)

(72) Inventors: Yuji TAKEDA, Shinagawa-ku, Tokyo (JP); Yuki KASAHARA, Shinagawa-ku, Tokyo (JP)

(21) Appl. No.: 17/281,830

(22) PCT Filed: Oct. 1, 2019
(86) PCT No.: PCT/JP2019/038768

§ 371 Date: Mar. 31, 2021

(30) Foreign Application Priority Data
Oct. 2, 2018 (JP) 2018-187569

(51) Int. Cl. C11D 11/00; C11D 1/83; C11D 3/36; C11D 3/20; C11D 3/33; C11D 3/04; C11D 3/28

(52) U.S. Cl. CPC C11D 11/0029; C11D 1/83; C11D 3/361; C11D 3/364; C11D 3/365; C11D 1/72; C11D 3/33; C11D 3/2096; C11D 3/046; C11D 3/042; C11D 3/28; C11D 3/2086

(57) ABSTRACT

The present invention provides a surface treatment agent which is capable of efficiently removing oily substances from the surface of a metal material, while removing scales and fumes therefrom at the same time.

A surface treatment agent which contains a chelating agent, a nonionic surfactant and an anionic surfactant, and which is configured such that the anionic surfactant is composed of at least one surfactant that is selected from the group consisting of phosphoric acid ester surfactants, carboxylic acid surfactants, sulfonic acid surfactants and sulfuric acid ester surfactants.

### TECHNICAL FIELD

The present invention relates to a surface treatment agent for use in removing an oily substance from a surface of a metal material, while simultaneously removing scale and fumes therefrom.

### BACKGROUND ART

Conventionally, a surface treatment agent containing a reducing agent, such as ascorbic acid, and a chelating agent has been proposed in order to remove scale and fumes adhered to a surface of a metal material (see Patent Document 1).

In the surface treatment agent described above, the reducing agent enhances solubilities of the scale and fumes, and the chelating agent forms a coordinate bond with metal ions of the scale and fumes.

Then, by the action of the reducing agent and the chelating agent, the scale and fumes adhered to the surface of the metal material can be simultaneously removed.

However, for example, a welded portion of an automotive component includes an oily substance that is adhered to it, in addition to the scale and fumes.

Further, the portion becomes a site where rust is likely to occur.

Furthermore, in the case where an oily substance is adhered in addition to the scale and fumes, there is a problem that formation of a chemical conversion film is difficult even when a chemical conversion treatment such as a zinc phosphate treatment or a Zr treatment is performed.

For this reason, it is necessary to remove an oily substance together with the scale and fumes before the chemical conversion treatment.

Patent Document 1: Japanese Unexamined Patent Application, Publication No. 2016-160457

### DISCLOSURE OF THE INVENTION

### Problems to be Solved by the Invention

However, with conventional surface treatment agents, although scale and fumes can be removed simultaneously, it has been difficult to efficiently remove an oily substance. Thus, the treatment of removing scale and fumes and the treatment of removing an oily substance were separately carried out to address the problem.

In various metal materials other than the welded portion of an automotive component, there has been a demand for a surface treatment agent capable of efficiently removing an oily substance simultaneously with scale and fumes from a surface of a metal material.

The present invention has been made in view of the above background, and an object of the present invention is to provide a surface treatment agent capable of efficiently removing an oily substance simultaneously with scale and fumes from a surface of a metal material.

### Means for Solving the Problems

The present inventors have conducted extensive research on a surface treatment agent capable of removing not only scale and fumes but also an oily substance simultaneously from a surface of a metal material.

As a result, it has been found that the above problem can be solved by using a surface treatment agent containing a chelating agent, a nonionic surfactant, and an anionic surfactant, in which the anionic surfactant is at least one selected from the group consisting of a phosphate ester type surfactant, a carboxylic acid type surfactant, a sulfonic acid type surfactant, and a sulfate ester type surfactant, thereby completing the present invention.

In other words, the present invention is a surface treatment agent for use in removing an oily substance simultaneously with scale and fumes from a surface of a metal material, the surface treatment agent including a chelating agent, a nonionic surfactant, and an anionic surfactant, in which the anionic surfactant is at least one selected from the group consisting of phosphate ester type surfactants, carboxylic acid type surfactants, sulfonic acid type surfactants, and sulfate ester type surfactants.

The chelating agent is at least one selected from the group consisting of phosphonic acid-based chelating agents, aminocarboxylic acid type chelating agents, and carboxyethyl group-based chelating agents, and the total content of the chelating agent may be 3,000 to 22,000 ppm by mass.

The nonionic surfactant is at least one selected from the group consisting of polyoxyalkylene glycol fatty acid esters, polyalkylene glycol fatty acid esters, and polyoxyalkylene alkyl ethers, and the total content of the nonionic surfactant may be 1,000 to 4,000 ppm by mass.

The total content of the anionic surfactant may be 2,000 to 8,000 ppm by mass.

The anionic surfactant may be a phosphate ester type surfactant.

The surface treatment agent further comprises a fluorine-containing compound that liberates fluoride ions, and the content of the fluorine-containing compound may be 500 to 3,000 ppm by mass.

The surface treatment agent further comprises a reducing agent, and the content of the reducing agent may be 5,000 to 15,000 ppm by mass.

The surface treatment agent further comprises a rust inhibitor, the content of the rust inhibitor may be 50 to 300 ppm by mass.

### Effect of the Invention

By using the surface treatment agent of the present invention, it is possible to efficiently remove an oily substance from a surface of a metal material simultaneously with scale and fumes.

### PREFERRED MODE FOR CARRYING OUT THE INVENTION

Below, embodiments of the present invention is described.

### <Surface Treatment Agent>

The surface treatment agent of the present invention includes a chelating agent, a nonionic surfactant, and an anionic surfactant, and the anionic surfactant is at least one selected from the group consisting of a phosphate ester type surfactant, a carboxylic acid type surfactant, a sulfonic acid type surfactant, and a sulfate ester type surfactant.

The surface treatment agent of the present invention may contain a chelating agent, a nonionic surfactant, and an anionic surfactant described above as essential components, and may optionally contain other components within a range not impairing the effect of the present invention.

Examples of the other components include a reducing agent, a rust inhibitor, and a fluorine-containing compound.

### [Chelating Agent]

The chelating agent contained in the surface treatment agent of the present invention is not particularly limited, and a known chelating agent can be applied.

By containing a chelating agent, the surface treatment agent of the present invention can efficiently remove scale and fumes from a surface of a metal material.

Examples of the chelating agent applicable to the surface treatment agent of the present invention include at least one selected from the group consisting of phosphonic acid-based chelating agents, aminocarboxylic acid type chelating agents, and carboxyethyl group-based chelating agents.

Herein, examples of the phosphonic acid-based chelating agents include HEDP, NTMP, PBTC, EDTMP, etc.

Examples of the aminocarboxylic acid type chelating agents include EDTA, NTA, DTPA, HEDTA, TTHA, PDTA, DPTA-oh, HIDA, DHEG, GEDTA, CMGA, EDDS, etc.
Examples of the carboxyethyl group-based chelating agents include citric acid, structural isomers of citric acid, adipic acid, aminohexanoic acid, etc.

The total content of the chelating agent contained in the surface treatment agent of the present invention is preferably 3,000 to 22,000 ppm by mass, and more preferably 5,000 to 13,000 ppm by mass.

When the total content of the chelating agent is less than 3,000 ppm by mass, it is difficult to remove scale and fumes from a surface of a metallic material.
On the other hand, when the total content of the chelating agent exceeds 22,000 ppm by mass, there is almost no improvement in removability, which is uneconomical.

### [Nonionic Surfactant]

The nonionic surfactant contained in the surface treatment agent of the present invention is not particularly limited, and a known nonionic surfactant can be applied.

By containing a nonionic surfactant, the surface treatment agent of the present invention can efficiently remove an oily substance from a surface of a metal material.

Examples of the nonionic surfactants applicable to the surface treatment agent of the present invention include at least one selected from the group consisting of polyoxyalkylene glycol fatty acid esters, polyalkylene glycol fatty acid esters, and polyoxyalkylene alkyl ethers. Commercially available products may also be applied, and examples thereof include Genapol EP 2564 (manufactured by Clariant Japan Co., Ltd.), Neugen XL100 (manufactured by DKS Co., Ltd.), Genagen C 100 (manufactured by Clariant Japan Co., Ltd.), and the like.

The total content of the nonionic surfactant contained in the surface treatment agent of the present invention is preferably 1,000 to 4,000 ppm by mass, and more preferably 2,000 to 4,000 ppm by mass.

When the total content of the nonionic surfactant is less than 1,000 ppm by mass, it is difficult to remove an oily substance from a surface of a metal material.
On the other hand, when the total content of the nonionic surfactant exceeds 4,000 ppm by mass, there is a concern that foaming tends to occur in the working process.

### [Anionic Surfactant]

The anionic surfactant contained in the surface treatment agent of the present invention is at least one selected from the group consisting of phosphate ester type surfactants, carboxylic acid type surfactants, sulfonic acid type surfactants, and sulfate ester type surfactants.

By containing an anionic surfactant, the surface treatment agent of the present invention can efficiently remove an oily substance from a surface of a metal material simultaneously with scale and fumes.
That is, anionic surfactants contribute to both removal of scale and fumes and removal of oily substances (degreasing).

The above-mentioned anionic surfactant is not particularly limited, and a known anionic surfactant can be applied. Commercially available products may also be applied, and examples thereof include DOW TRITON H66 (potassium phosphate type surfactant manufactured by Dow Chemical Japan Co., Ltd.), Neogen AS-20 (sulfonic acid type surfactant manufactured by DKS Co., Ltd.), Neugen ES-99 (manufactured by DKS Co., Ltd.), Sun Spear PDN-173 (carboxylic acid type surfactant manufactured by Sanyo Chemical Industries Ltd.), and the like.

It is preferable for the surface treatment agent of the present invention to include a phosphate ester type surfactant, among the above-mentioned anionic surfactants.

Examples of the phosphate ester type surfactant include an EO-added phosphate ester, a phosphite ester, an acidic phosphate ester, and a phosphonate ester, etc. and it is preferable for the surface treatment agent of the present invention to include at least one selected from the group consisting of these.

Herein, the EO-added phosphate ester is represented by the following formula (1):

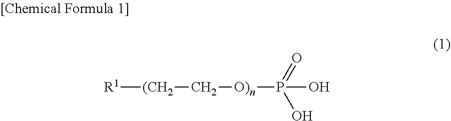

wherein R² represents an alkyl group having 1 or more carbon atoms, and n is 1 or more.

Further, the phosphite ester is represented by the following formula (2):

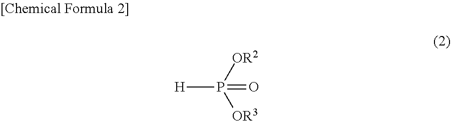

wherein R² and R³ each represent an alkyl group having one or more carbon atoms.

Further, the acidic phosphate ester is represented by the following formula (3):

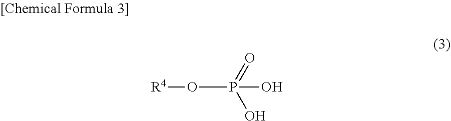

wherein R⁴ each represents an alkyl group having 1 or more carbon atoms.

Further, the phosphonate ester is represented by the following formula (4):

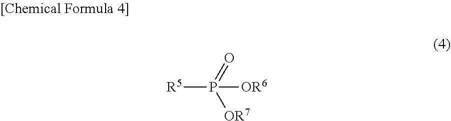

wherein R⁵, R⁶ and R⁷ each represents an alkyl group having 1 or more carbon atoms.

The total content of the anionic surfactant contained in the surface treatment agent of the present invention is preferably 2,000 to 8,000 ppm by mass, and more preferably 4,000 to 8,000 ppm by mass.

When the total content of the phosphate ester type surfactant is less than 2,000 ppm by mass, it is difficult to remove an oily substance from a surface of a metal material.
On the other hand, when the total content of the phosphate ester type surfactant exceeds 8,000 ppm by mass, there is a concern that foaming tends to occur in the working process.

### [Other Components]

The surface treatment agent of the present invention may further contain other components within a range not impairing the effect of the present invention.

The other component is not particularly limited as long as the other component is a known compound applicable to surface treatment agents, and for example, a reducing agent, a rust inhibitor, or a fluorine-containing compound can impart a further function to the surface treatment agent.

### (Reducing Agent)

The reducing agent optionally contained in the surface treatment agent of the present invention is not particularly limited, and a known reducing agent can be applied.

By further including a reducing agent, the surface treatment agent of the present invention can enhance the solubility of scale and fumes present on a surface of a metal material, and thereby the surface treatment agent of the present invention can further efficiently remove the scale and fumes from the surface of the metal material.

Examples of the reducing agent which can be applied to the surface treatment agent of the present invention include an ascorbic acid-based reducing agent, such as ascorbic acid, erythroascorbic acid, isoascorbic acid, ascorbic acid derivatives, etc.; ersorbic acid; gallic acid; pyrogallol; hydrazine; a sulfur-based reducing agent; thiourea; etc.

When a reducing agent is applied to the surface treatment agent of the present invention, the content thereof is preferably 5,000 to 15,000 ppm by mass.

When the content of the reducing agent is less than 5,000 ppm by mass, it is difficult to enhance the solubility of scale and fumes present on the surface of the metallic material. On the other hand, when the content of the reducing agent exceeds 15,000 ppm by mass, there is almost no improvement in the effect of enhancing the solubility of the scale and fumes present on the surface of the metallic material, which is uneconomical.

### (Rust Inhibitor)

The rust inhibitor optionally contained in the surface treatment agent of the present invention is not particularly limited, and a known rust inhibitor can be applied.

By further containing a rust inhibitor, the surface treatment agent of the present invention can enhance the rust proofing property of the metal material until a chemical conversion treatment is performed.

Examples of the rust inhibitor applicable to the surface treatment agent of the present invention include so-called P-based, N-based, S-based, and acetylene-based rust inhibitors, etc.

Examples of the P-based rust inhibitor include phosphates and the like.
Examples of the N-based reducing agent include alkylamines, imidazole, triazole, etc.
Examples of the S-based rust inhibitor include Santhiol, thiourea, etc.

Examples of the acetylene-based rust inhibitor include 3-methyl-1-butyn-3-ol, 3-methyl-1-pentyn-3-ol, 2,5-dimethyl-3-hexyne-2,5-diol, 3,6-dimethyl-4-octyne-3,6-diol, etc. Commercially available products may also be applied, and examples thereof include KORANTIN PM (manufactured by BASF Japan Co., Ltd.).

When a rust inhibitor is applied to the surface treatment agent of the present invention, the content thereof is preferably 50 to 300 ppm by mass.

When the content of the rust inhibitor is less than 50 ppm by mass, it is difficult to enhance the rust proofing property of the metal material.
On the other hand, when the total content of the rust inhibitor exceeds 225 ppm by mass, there is almost no further improvement in the effect, which is uneconomical.

### (Fluorine-Containing Compounds)

The fluorine-containing compound optionally contained in the surface treatment agent of the present invention is not particularly limited as long as it liberates fluoride ions, and a known compound can be applied.

By further containing a fluorine-containing compound that liberates fluoride ions, the surface treatment agent of the present invention can stabilize metal ions in the scale and fumes, in an aqueous solution, and thereby can further efficiently remove the scale and fumes from a surface of a metal material.

Examples of the fluorine-containing compound serving as a supply source for fluoride ions include hydrofluoric acid, acidic sodium fluoride, acidic ammonium fluoride, fluorotitanic acid, fluorozirconic acid, fluorosilicic acid, ammonium fluoride, sodium fluoride, potassium fluoride, potassium hydrogen difluoride, etc.

When the fluorine-containing compound is applied to the surface treatment agent of the present invention, the content thereof is preferably, for example, 500 to 3,000 ppm by mass, and more preferably 750 to 1,250 ppm by mass.

When the total content of the fluorine-containing compound is less than 500 ppm by mass, it is difficult to stabilize metal ions in the scale and fumes in an aqueous solution.

### <Surface Treatment Method>

A surface treatment method using the surface treatment agent of the present invention is not particularly limited, and for example, the following method can be applied.

### [Metal Material]

The metal material to which the surface treatment agent of the present invention can be applied is not particularly limited.

Examples include, but are not limited to, iron materials, cold-rolled steel sheets, hot-rolled steel sheets, galvanized steel sheets, aluminum alloy materials, etc.
It should be noted that a metal material having a welded portion needs efficient removal of scale, fumes, and an oily substance from the surface thereof, and thus can particularly enjoy the effect of the present invention.

The temperature of the surface treatment agent during surface treatment is, for example, 35 to 60° C.

When the temperature of the surface treatment agent is less than 35° C., it is difficult to remove scale and fumes from a surface of a metal material.
On the other hand, the temperature of the surface treatment agent exceeding 60° C. is undesirable, because there is almost no improvement in removability and deterioration of treatment equipment is accelerated.
The temperature of the surface treatment agent is preferably 40 to 60° C., and more preferably 45 to 55° C.

The pH of the surface treatment agent when performing surface treatment is, for example, 4 to 8.

At a pH in this range, scale and fumes can be efficiently removed from a surface of a metallic material.
The pH of the surface treatment agent is preferably in the range of 4.5 to 7.
When the pH of the surface treatment agent is less than 4, color of the surface of the metal material may be changed to black, depending on the metal material.
On the other hand, when the pH of the surface treatment agent exceeds 8, it is difficult to remove scale and fumes from a surface of a metal material.
The pH of the surface treatment agent is preferably in the range of 4.5 to 7, and more preferably in the range of 4.5 to 6.

The time in surface treatment is, for example, 30 to 300 seconds, and more preferably, 60 to 180 seconds.

When the time for surface treatment is less than 30 seconds, it is difficult to remove scale and fumes from a surface of a metal material.
On the other hand, when the time for surface treatment exceeds 300 seconds, there is almost no improvement in removability.

As described above, the surface treatment agent of the present invention is a surface treatment agent for use in removing an oily substance simultaneously with scale and fumes from a surface of a metal material, and includes a chelating agent, a nonionic surfactant, and an anionic surfactant, and the anionic surfactant is at least one selected from the group consisting of a phosphate ester type surfactant, a carboxylic acid type surfactant, a sulfonic acid type surfactant, and a sulfate ester type surfactant.

By using such a surface treatment agent, scale, fumes, and an oily substance can be efficiently removed from a surface of a metal material at the same time.

Note that the present invention is not limited to the above embodiments, and includes modifications and improvements thereof, within a scope in which the object of the present invention can be achieved.

### EXAMPLES

Hereinafter, the present invention will be described in more detail based on the Examples and the like, but the present invention is not limited to these Examples, etc. The compounds used in the Examples and the Comparative Examples are indicated below.

(1) Chelating agent

Phosphonic acid-based chelating agent
HEDP: 1-hydroxyethane-1,1-diphosphonic acid
NTMP: nitrilotris(methylene phosphonic acid)
PBTC: 2-phosphonobutane-1,2,4-tricarboxylic acid

Carboxyethyl group-based chelating agent
Citric acid

Aminocarboxylic acid type chelating agent
EDTA: ethylenediaminetetraacetic acid
   (2) Nonionic surfactant
Adecanol UA90N (manufactured by ADEKA Corporation): polyoxyalkylene alkyl ethers
Genapol EP2564 (manufactured by Clariant Japan Co., Ltd.): polyoxyalkylene alkyl ethers
Genagen C 100 (manufactured by Clariant Japan Co., Ltd.): polyoxyalkylene fatty acid esters
   (3) Anionic surfactant

Potassium phosphate-type surfactant
Triton H66 (Dow Chemical Japan Co., Ltd.)

Carboxylic acid type surfactant
Sun Spear PDN-173 (Sanyo Chemical Industries, Ltd.)

Sulfonic acid type surfactant
NEOGEN AS20 (DKS Co., Ltd.)
   (4) Reducing agent
Ascorbic acid (Vitamin C (L-ascorbic acid) manufactured by Fuso Chemical Co., Ltd.)
Thiourea
Pyrogallol
   (5) Rust inhibitor
KORANTIN PM (manufactured by BASF Japan Co., Ltd.)
Santhiol N-1 (manufactured by Sankyo Chemical Co., Ltd.)
Imidazole (manufactured by Nihon Gosei Kako Co., Ltd.)
   (6) Fluoride compound
Acidic sodium fluoride
Potassium fluoride
Hydrofluoric acid

### Example 1

### [Preparation of Metal Material]

Two types of steel sheets, hot rolled steel sheets and galvanized steel sheets, were prepared as metal materials to be treated, and welding was carried out on the respective steel sheets to which oil was adhered.

A metal material of the hot-rolled steel sheets (hereinafter referred to as an S material) included scale and oil adhered to a bead portion and its vicinity. A metal material of the galvanized steel sheets (hereinafter referred to as a G material) included fumes and oil adhered to a bead portion and its vicinity. These metal materials were used as test pieces.

### [Preparation of Surface Treatment Agent]

HEDP as the chelating agent, Adecanol UA90N as the nonionic surfactant, Triton H66 as the anionic surfactant, KORANTIN PM as the rust inhibitor, and acidic sodium fluoride as the fluoride compound were mixed in water so as to have the contents indicated in Table 1 (unit: ppm by mass), and an aqueous KOH solution (50%) was used to adjust to pH 5 to obtain a surface treatment agent.

TABLE 1

| | | Example | Example | Example | Example | Example |
|---|---|---|---|---|---|---|
| | | 1 | 2 | 3 | 4 | 5 |
| Chelating | HEDP | 3000 | 5000 | 10000 | | |
| agent | Citric acid | | | | 3000 | 5000 |
| | NTMP | | | | | |
| | PBTC | | | | | |
| | EDTA | | | | | |
| Nonionic | Adecanol UA90N | 2000 | 2000 | 2000 | 2000 | 2000 |
| surfactant | Genapol EP2564 | | | | | |
| | Genagen C 100 | | | | | |
| Anionic | Triton H66 | 4000 | 4000 | 4000 | 4000 | 4000 |
| surfactant | San Spear PDN-173 | | | | | |
| | Neogen AS20 | | | | | |
| Reducing | Ascorbic acid | | | | | |
| agent | Thiourea | | | | | |
| | Pyrogallol | | | | | |
| Rust | KORANTIN PM | 225 | 225 | 225 | 225 | 225 |
| inhibitor | Santhiol N-1 | | | | | |
| | Imidazole | | | | | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 3 | 3 | 4 | 3 | 3 |
| | G material | 3 | 3 | 4 | 3 | 3 |
| Wettability | | 5 | 5 | 5 | 5 | 5 |
| Rust proofing property | | 5 | 5 | 5 | 5 | 5 |
| | | Example | Example | Example | Example | Example |
| | | 6 | 7 | 8 | 9 | 10 |
| Chelating | HEDP | | | | | |
| agent | Citric acid | 8000 | 10000 | | | |
| | NTMP | | | 3000 | | |
| | PBTC | | | | 3000 | |
| | EDTA | | | | | 3000 |
| Nonionic | Adecanol UA90N | 2000 | 2000 | 2000 | 2000 | 2000 |
| surfactant | Genapol EP2564 | | | | | |
| | Genagen C 100 | | | | | |
| Anionic | Triton H66 | 4000 | 4000 | 4000 | 4000 | 4000 |
| surfactant | San Spear PDN-173 | | | | | |
| | Neogen AS20 | | | | | |
| Reducing | Ascorbic acid | | | | | |
| agent | Thiourea | | | | | |
| | Pyrogallol | | | | | |
| Rust | KORANTIN PM | 225 | 225 | 225 | 225 | 225 |
| inhibitor | Santhiol N-1 | | | | | |
| | Imidazole | | | | | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 3 | 3 | 3 | 3 | 3 |
| | G material | 4 | 4 | 3 | 3 | 3 |

| | | | | | |
|---|---|---|---|---|---|
| Wettability | 5 | 5 | 5 | 5 | 5 |
| Rust proofing property | 5 | 5 | 5 | 5 | 5 |

### [Surface Treatment]

The surface treatment agent was placed in a 10 L treatment bath, the temperature was adjusted to 50° C., and stirring was carried out at a stirring rate of about 150 rpm.

The S material and the G material were each immersed in the treatment bath for 2 minutes, then taken out, and thoroughly washed.
After washing, drying was performed at 40° C. for about 10 minutes to obtain surface treated sheets.

### [Surface Adjustment]

With respect to each of the S material and G material subjected to the surface treatment with the surface treatment agent, surface adjustment was performed using a Surffine GL1 (manufactured by Nippon Paint Surf Chemicals Co., Ltd.) that had been adjusted to pH 10, to obtain surface adjusted sheets. The treatment temperature was room temperature and the treatment time was 120 seconds.

### [Chemical Conversion Treatment]

Subsequently, with respect to each of the S material and G material subjected to the surface adjustment, chemical conversion treatment was carried out using Surfdine SD6350 (manufactured by Nippon Paint Surf Chemicals Co., Ltd.), to obtain chemical conversion treated materials on which a rust preventive film was formed.

The treatment temperature was 35° C. and the treatment time was 120 seconds.

### [Evaluation]

The following evaluations were performed on the metal materials after surface treatment and the metal materials after chemical conversion treatment.

The results are indicated in Table 1.

### (Removability)

### {S Material}

The S material after chemical conversion treatment was evaluated for removability by visual observation according to the following evaluation criteria.

With respect to the S material, removability of a mixture of scale and oil was evaluated.

5: Scale could be almost completely removed (removal rate: more than 80% and 100% or less),

4: scale could be mostly removed (removal rate: more than 60% and 80% or less),

3: about half of the scale could be removed (removal rate: more than 40% and 60% or less),

2: scale could be slightly removed (removal rate: greater than 10% and 40% or less), and

1: almost no scale could be removed (removal rate: 10% or less).

### {G Material}

The G material after chemical conversion treatment was evaluated for removability by visual observation according to the following evaluation criteria.

With respect to the G material, removability of a mixture of fumes and oil was evaluated.

5: Fumes could be almost completely removed (removal rate: more than 80% and 100% or less),

4: fumes could be mostly removed (removal rate: more than 60% and 80% or less),

3: about half of the fumes could be removed (removal rate: more than 40% and 60% or less),

2: fumes could be slightly removed (removal rate: greater than 10% and 40% or less), and

1: almost no fumes could be removed (removal rate: 10% or less).

### (Wettability)

The S material subjected to surface treatment with the surface treatment agent was washed with water, allowed to stand for about 30 seconds, and then evaluated for the wettability according to the following evaluation criteria. Note that good wettability means that an oily substance was removed.

When degreasing was insufficient, the steel sheet was in a state in which the surface of the steel sheet repelled water and was not wet.

5: a surface of steel sheet was completely wet (water wetting rate: 100%),

4: a surface of steel sheet was mostly wet (water wetting rate: more than 80% and less than 100%),

3: a surface of steel sheet was wet to some extent (water wetting rate: greater than 60% and 80% or less),

2: a surface of steel sheet was not very wet (water wetting rate: greater than 0% and 60% or less), and

1: a surface of steel sheet was not wet at all (water wetting rate: 0%).

### (Rust Proofing Property)

The S material subjected to surface treatment with the surface treatment agent was washed with water, allowed to stand at room temperature while wet, and the amount of rust generated after 5 minutes was evaluated based on the following criteria:

5: rust was not generated at all or very little (rust generation rate: 20% or less);

4: rust was slightly generated (rust generation rate: more than 20% and 40% or less);

3: rust was partially generated (rust generation rate: more than 40% and 60% or less);

2: rust was largely generated (rust generation rate: more than 60% and 80% or less); and

1: rust was generated on almost the entire surface (rust generation rate: more than 80% and 100% or less).

### Examples 2 to 10

The surface treatment and chemical conversion treatment were carried out in the same manner as in Example 1, except that the type and the blending amount of the chelating agent were changed as described in Table 1, and evaluation was performed.

The results are given in Table 1.

### Examples 11 to 16

The surface treatment and chemical conversion treatment were carried out in the same manner as in Example 1, except that two types of chelating agents were used and the type and the blending amount thereof were set as described in Table 2, and evaluation was performed.

The results are given in Table 2.

TABLE 2

| | | Example | Example | Example | Example | Example | Example |
|---|---|---|---|---|---|---|---|
| | | 11 | 12 | 13 | 14 | 15 | 16 |
| Chelating | HEDP | 3000 | 3000 | 3000 | 1000 | 5000 | 12000 |
| agent | Citric acid | 4000 | 10000 | 12000 | 10000 | 10000 | 10000 |
| | NTMP | | | | | | |
| | PBTC | | | | | | |
| | EDTA | | | | | | |
| Nonionic | Adecanol UA90N | 2000 | 2000 | 2000 | 2000 | 2000 | 2000 |
| surfactant | Genapol EP2564 | | | | | | |
| | Genagen C 100 | | | | | | |
| Anionic | Triton H66 | 4000 | 4000 | 4000 | 4000 | 4000 | 4000 |
| surfactant | San Spear PDN-173 | | | | | | |
| | Neogen AS20 | | | | | | |
| Reducing | Ascorbic acid | | | | | | |
| agent | Thiourea | | | | | | |
| | Pyrogallol | | | | | | |
| Rust | KORANTIN PM | 225 | 225 | 225 | 225 | 225 | 225 |
| inhibitor | Santhiol N-1 | | | | | | |
| | Imidazole | | | | | | |
| Fluoride | Sodium bifluoride | 1000 | 1000 | 1000 | 1000 | 1000 | 1000 |
| | Potassium fluoride | | | | | | |
| | Hydrofluoric acid | | | | | | |
| pH | | 5 | 5 | 5 | 5 | 5 | 5 |
| Temperature | | 50 | 50 | 50 | 50 | 50 | 50 |
| Removability | S material | 4 | 4 | 4 | 4 | 4 | 5 |
| | G material | 3 | 4 | 4 | 4 | 4 | 5 |

| | | | | | | |
|---|---|---|---|---|---|---|
| Wettability | 5 | 5 | 5 | 5 | 5 | 5 |
| Rust proofing property | 5 | 5 | 5 | 5 | 5 | 5 |

### Examples 17 to 26

The surface treatment and chemical conversion treatment were carried out in the same manner as in Example 1, except that the type and the blending amount of the nonionic surfactant and anionic surfactant were set as described in Table 3, and evaluation was performed.

The results are given in Table 3.

TABLE 3

| | | Example | Example | Example | Example | Example |
|---|---|---|---|---|---|---|
| | | 17 | 18 | 19 | 20 | 21 |
| Chelating | HEDP | 3000 | 3000 | 3000 | 3000 | 3000 |
| agent | Citric acid | 10000 | 10000 | 10000 | 10000 | 10000 |
| | NTMP | | | | | |
| | PBTC | | | | | |
| | EDTA | | | | | |
| Nonionic | Adecanol UA90N | 1000 | 4000 | 4000 | | |
| surfactant | Genapol EP2564 | | | | 2000 | |
| | Genagen C 100 | | | | | 2000 |
| Anionic | Triton H66 | 4000 | 2000 | 4000 | 4000 | 4000 |
| surfactant | San Spear PDN-173 | | | | | |
| | Neogen AS20 | | | | | |
| Reducing | Ascorbic acid | | | | | |
| agent | Thiourea | | | | | |
| | Pyrogallol | | | | | |
| Rust | KORANTIN PM | 225 | 225 | 225 | 225 | 225 |
| inhibitor | Santhiol N-1 | | | | | |
| | Imidazole | | | | | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 3 | 3 | 4 | 4 | 4 |
| | G material | 4 | 4 | 4 | 4 | 4 |
| Wettability | | 3 | 3 | 5 | 5 | 5 |
| Rust proofing property | | 5 | 5 | 5 | 5 | 5 |
| | | Example | Example | Example | Example | Example |
| | | 22 | 23 | 24 | 25 | 26 |
| Chelating | HEDP | 3000 | 3000 | 3000 | 3000 | 3000 |
| agent | Citric acid | 10000 | 10000 | 10000 | 10000 | 10000 |
| | NTMP | | | | | |
| | PBTC | | | | | |
| | EDTA | | | | | |
| Nonionic | Adecanol UA90N | 2000 | 2000 | 2000 | 2000 | 4000 |
| surfactant | Genapol EP2564 | | | | | |
| | Genagen C 100 | | | | | |
| Anionic | Triton H66 | | | 2000 | 8000 | 8000 |
| surfactant | San Spear PDN-173 | 4000 | | | | |
| | Neogen AS20 | | 4000 | | | |
| Reducing | Ascorbic acid | | | | | |
| agent | Thiourea | | | | | |
| | Pyrogallol | | | | | |
| Rust | KORANTIN PM | 225 | 225 | 225 | 225 | 225 |
| inhibitor | Santhiol N-1 | | | | | |
| | Imidazole | | | | | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 4 | 4 | 4 | 4 | 4 |
| | G material | 4 | 4 | 4 | 4 | 4 |

| | | | | | |
|---|---|---|---|---|---|
| Wettability | 5 | 5 | 5 | 5 | 5 |
| Rust proofing property | 5 | 5 | 5 | 5 | 5 |

### Examples 27 to 36

The surface treatment and chemical conversion treatment were carried out in the same manner as in Example 1, except that the reducing agent and the rust inhibitor were blended as described in Table 4, and evaluation was performed.

The results are given in Table 4.

TABLE 4

| | | Example | Example | Example | Example | Example |
|---|---|---|---|---|---|---|
| | | 27 | 28 | 29 | 30 | 31 |
| Chelating | HEDP | 3000 | 3000 | 3000 | 3000 | 3000 |
| agent | Citric acid | 10000 | 10000 | 10000 | 10000 | 10000 |
| | NTMP | | | | | |
| | PBTC | | | | | |
| | EDTA | | | | | |
| Nonionic | Adecanol UA90N | 2000 | 2000 | 2000 | 2000 | 2000 |
| surfactant | Genapol EP2564 | | | | | |
| | Genagen C 100 | | | | | |
| Anionic | Triton H66 | 4000 | 4000 | 4000 | 4000 | 4000 |
| surfactant | San Spear PDN-173 | | | | | |
| | Neogen AS20 | | | | | |
| Reducing | Ascorbic acid | 3000 | 5000 | 15000 | | |
| agent | Thiourea | | | | 5000 | |
| | Pyrogallol | | | | | 5000 |
| Rust | KORANTIN PM | 225 | 225 | 225 | 225 | 225 |
| inhibitor | Santhiol N-1 | | | | | |
| | Imidazole | | | | | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 4 | 5 | 5 | 5 | 5 |
| | G material | 3 | 3 | 4 | 4 | 4 |
| Wettability | | 5 | 5 | 5 | 5 | 5 |
| Rust proofing property | | 5 | 5 | 5 | 5 | 5 |
| | | Example | Example | Example | Example | Example |
| | | 32 | 33 | 34 | 35 | 36 |
| Chelating | HEDP | 3000 | 3000 | 3000 | 3000 | 3000 |
| agent | Citric acid | 10000 | 10000 | 10000 | 10000 | 10000 |
| | NTMP | | | | | |
| | PBTC | | | | | |
| | EDTA | | | | | |
| Nonionic | Adecanol UA90N | 2000 | 2000 | 2000 | 2000 | 2000 |
| surfactant | Genapol EP2564 | | | | | |
| | Genagen C 100 | | | | | |
| Anionic | Triton H66 | 4000 | 4000 | 4000 | 4000 | 4000 |
| surfactant | San Spear PDN-173 | | | | | |
| | Neogen AS20 | | | | | |
| Reducing | Ascorbic acid | | | | | |
| agent | Thiourea | | | | | |
| | Pyrogallol | | | | | |
| Rust | KORANTIN PM | 0 | 50 | | | 450 |
| inhibitor | Santhiol N-1 | | | 225 | | |
| | Imidazole | | | | 225 | |
| Fluoride | Sodium bifluoride | 1000 | 1000 | 1000 | 1000 | 1000 |
| | Potassium fluoride | | | | | |
| | Hydrofluoric acid | | | | | |
| pH | | 5 | 5 | 5 | 5 | 5 |
| Temperature | | 50 | 50 | 50 | 50 | 50 |
| Removability | S material | 4 | 4 | 4 | 4 | 4 |
| | G material | 4 | 4 | 4 | 4 | 4 |

| | | | | | |
|---|---|---|---|---|---|
| Wettability | 5 | 5 | 5 | 5 | 5 |
| Rust proofing property | 2 | 3 | 5 | 5 | 5 |

### Examples 37 to 42

The surface treatment and chemical conversion treatment were carried out in the same manner as in Example 1, except that the type and the blending amount of the fluoride compound were set as described in Table 5, and evaluation was performed.

The results are given in Table 5.

TABLE 5

| | | Example | Example | Example | Example | Example | Example |
|---|---|---|---|---|---|---|---|
| | | 37 | 38 | 39 | 40 | 41 | 42 |
| Chelating | HEDP | 3000 | 3000 | 3000 | 3000 | 3000 | 3000 |
| agent | Citric acid | 10000 | 10000 | 10000 | 10000 | 10000 | 10000 |
| | NTMP | | | | | | |
| | PBTC | | | | | | |
| | EDTA | | | | | | |
| Nonionic | Adecanol UA90N | 2000 | 2000 | 2000 | 2000 | 2000 | 2000 |
| surfactant | Genapol EP2564 | | | | | | |
| | Genagen C 100 | | | | | | |
| Anionic | Triton H66 | 4000 | 4000 | 4000 | 4000 | 4000 | 4000 |
| surfactant | San Spear PDN-173 | | | | | | |
| | Neogen AS20 | | | | | | |
| Reducing | Ascorbic acid | | | | | | |
| agent | Thiourea | | | | | | |
| | Pyrogallol | | | | | | |
| Rust | KORANTIN PM | 225 | 225 | 225 | 225 | 225 | 225 |
| inhibitor | Santhiol N-1 | | | | | | |
| | Imidazole | | | | | | |
| Fluoride | Sodium bifluoride | 0 | 500 | 3000 | 5000 | | |
| | Potassium fluoride | | | | | 5000 | |
| | Hydrofluoric acid | | | | | | 5000 |
| pH | | 5 | 5 | 5 | 5 | 5 | 5 |
| Temperature | | 50 | 50 | 50 | 50 | 50 | 50 |
| Removability | S material | 3 | 5 | 5 | 5 | 5 | 5 |
| | G material | 4 | 4 | 4 | 4 | 4 | 4 |

| | | | | | | |
|---|---|---|---|---|---|---|
| Wettability | 5 | 5 | 5 | 5 | 5 | 5 |
| Rust proofing property | 5 | 5 | 5 | 5 | 5 | 5 |

### Examples 43 to 50

The surface treatment and chemical conversion treatment were carried out in the same manner as in Example 1, except that the pH and temperature of the surface treatment agent were set as described in Table 6, and evaluation was performed.

The results are given in Table 6.

TABLE 6

| | | Example | Example | Example | Example | Example | Example | Example | Example |
|---|---|---|---|---|---|---|---|---|---|
| | | 43 | 44 | 45 | 46 | 47 | 48 | 49 | 50 |
| Chelating | HEDP | 3000 | 3000 | 3000 | 3000 | 3000 | 3000 | 3000 | 3000 |
| agent | Citric acid | 10000 | 10000 | 10000 | 10000 | 10000 | 10000 | 10000 | 10000 |
| | Phosphonic acid | | | | | | | | |
| | PBTC | | | | | | | | |
| | EDTA | | | | | | | | |
| Nonionic | Adecanol UA90 | 2000 | 2000 | 2000 | 2000 | 2000 | 2000 | 2000 | 2000 |
| surfactant | Genapol EP2564 | | | | | | | | |
| | Neugen XL100 | | | | | | | | |
| Anionic | Triton H66 | 4000 | 4000 | 4000 | 4000 | 4000 | 4000 | 4000 | 4000 |
| surfactant | Neugen ES-99 | | | | | | | | |
| | Neogen AS20 | | | | | | | | |
| Reducing | Ascorbic acid | | | | | | | | |
| agent | Thiourea | | | | | | | | |
| | Pyrogallol | | | | | | | | |
| Rust | KORANTIN PM | 225 | 225 | 225 | 225 | 225 | 225 | 225 | 225 |
| inhibitor | Santhiol N-1 | | | | | | | | |
| | Imidazole | | | | | | | | |
| Fluoride | Sodium bifluoride | 1000 | 1000 | 1000 | 1000 | 1000 | 1000 | 1000 | 1000 |
| | Potassium fluoride | | | | | | | | |
| | Hydrofluoric acid | | | | | | | | |
| pH | | 4 | 4.5 | 6 | 7 | 8 | 5 | 5 | 5 |
| Temperature | | 50 | 50 | 50 | 50 | 3 | 35 | 40 | 60 |
| Removability | S material | 4 | 4 | 4 | 3 | 3 | 3 | 3 | 4 |
| | G material | 3 | 4 | 4 | 3 | 3 | 3 | 4 | 4 |

| | | | | | | | | |
|---|---|---|---|---|---|---|---|---|
| Wettability | 5 | 5 | 5 | 5 | 3 | 4 | 5 | 5 |
| Rust proofing property | 5 | 5 | 5 | 5 | 5 | 4 | 5 | 5 |

### Comparative Example 1

The surface treatment and chemical conversion treatment were carried out in the same manner as in Example 1, except that a degreasing agent containing no chelating agent: Surf Cleaner EC92 (manufactured by Nippon Paint Surf Chemicals Co., Ltd., concentration: 1.6% of Surf Cleaner EC92M and 0.54% of Surf Cleaner EC92LA-1) was used as the surface treatment agent, and evaluation was performed.

The results are given in Table 7.

TABLE 7

| | | Comparative | Comparative | Comparative | Comparative | Comparative |
|---|---|---|---|---|---|---|
| | | Example 1 | Example 2 | Example 3 | Example 4 | Example 5 |
| Chelating | HEDP | | | 3000 | 3000 | 3000 |
| agent | Citric acid | | | 10000 | 10000 | 10000 |
| | NTMP | | | | | |
| | PBTC | | | | | |
| | EDTA | | | | | |
| Nonionic | Adecanol UA90N | 1500 | — | — | — | 2000 |
| surfactant | Genapol EP2564 | | | | | |
| | Genagen C 100 | | | | | |
| Anionic | Triton H66 | — | — | — | 4000 | — |
| surfactant | San Spear PDN-173 | | | | | |
| | Neogen AS20 | | | | | |
| Reducing | Ascorbic acid | | | | | |
| agent | Thiourea | | | | | |
| | Pyrogallol | | | | | |
| Rust | KORANTIN PM | | | 225 | 225 | 225 |
| inhibitor | Santhiol N-1 | | | | | |
| | Imidazole | | | | | |
| Fluoride | Sodium bifluoride | | | 1000 | 1000 | 1000 |
| | Potassium fluoride | | | | | |
| | Hydrofluoric acid | | | | | |
| pH | | 11 | 2 | 5 | 5 | 5 |
| Temperature | | 40 | 50 | 50 | 50 | 50 |
| Removability | S material | 1 | 5 | 2 | 3 | 3 |
| | G material | 1 | 1 | 2 | 4 | 3 |

| | | | | | |
|---|---|---|---|---|---|
| Wettability | 5 | 2 | 1 | 2 | 1 |
| Rust proofing property | 1 | 1 | 5 | 5 | 5 |

### Comparative Example 2

The surface treatment and chemical conversion treatment were carried out in the same manner as in Example 1, except that a descaling agent containing no chelating agent: Surf Derust 171 (manufactured by Nippon Paint Surf Chemicals Co., Ltd., concentration: 20%) was used as the surface treatment agent, and evaluation was performed.

The results are given in Table 7.

### Comparative Examples 3 to 5

The surface treatment and chemical conversion treatment were carried out in the same manner as in Example 1, except that the components of the surface treatment agent were set as described in Table 1, and evaluation was performed.

The results are given in Table 7.

1. A surface treatment agent for use in removing an oily substance simultaneously with scale and fumes from a surface of a metal material,
the surface treatment agent comprising a chelating agent, a nonionic surfactant, and an anionic surfactant,
wherein the anionic surfactant is at least one selected from the group consisting of phosphate ester type surfactants, carboxylic acid type surfactants, sulfonic acid type surfactants, and sulfate ester type surfactants.

2. The surface treatment agent according to claim 1,
wherein the chelating agent is at least one selected from the group consisting of phosphonic acid-based chelating agents, aminocarboxylic acid type chelating agents, and carboxyethyl group-based chelating agents, and
a total content of the chelating agent is 3,000 to 22,000 ppm by mass.

3. The surface treatment agent according to claim 1,
wherein the nonionic surfactant is at least one selected from the group consisting of polyoxyalkylene glycol fatty acid esters, polyalkylene glycol fatty acid esters, and polyoxyalkylene alkyl ethers, and
a total content of the nonionic surfactant is 1,000 to 4,000 ppm by mass.

4. The surface treatment agent according to claim 1,
wherein the total content of the anionic surfactant is 2,000 to 8,000 ppm by mass.

5. The surface treatment agent according to claim 1, wherein the anionic surfactant is a phosphate ester type surfactant.

6. The surface treatment agent according to claim 1,
wherein the surface treatment agent further comprises a fluorine-containing compound that liberates fluoride ions, and a content of the fluorine-containing compound is 500 to 3,000 ppm by mass.

7. The surface treatment agent according to claim 1,
wherein the surface treatment agent further comprises a reducing agent, and a content of the reducing agent is 5,000 to 15,000 ppm by mass.

8. The surface treatment agent according to claim 1,
wherein the surface treatment agent further comprises a rust inhibitor, and
a content of the rust inhibitor is 50 to 300 ppm by mass.
